(19) United States
(12) Patent Application Publication
(10) Pub. No.: US 2011/0222041 A1
(43) Pub. Date: Sep. 15, 2011

(54) APPARATUS, METHOD, AND LITHOGRAPHY SYSTEM

(75) Inventor: Yasuyuki Unno, Tucson, AZ (US)

(73) Assignee: CANON KABUSHIKI KAISHA, Tokyo (JP)

(21) Appl. No.: 12/723,401

(22) Filed: Mar. 12, 2010

(51) Int. Cl. G03B 27/72; G01J 1/20

(52) U.S. Cl. 355/71; 250/201.1

(57) ABSTRACT

An apparatus which can measure an aerial image is provided. The apparatus includes an aperture configured to transmit light of the aerial image, a detector configured to detect the transmitted light at a plurality of first relative positions to the aperture, a controller configured to control a second relative position of the aperture to the aerial image, and a processor configured to generate information about the aerial image based on data obtained from the detector at each first relative position by controlling the second relative position of the aperture and position data about the first relative positions.

### BACKGROUND OF THE INVENTION

1. Field of the Invention

The present invention relates to aerial image measurement, and particularly relates to measurement of an aerial image produced by an optical lithography system.

2. Description of the Related Art

FIG. 1A shows a configuration of a typical optical lithography system 1001 used for manufacturing semiconductor devices. A wafer 1003 is positioned on a wafer stage 1006, and an illumination system 1004 illuminates a pattern on a reticle 1002 thereby generating light beams that are projected onto the wafer 1003 by a projection lens 1007 to form an aerial image corresponding to the pattern.

In the optical lithography system, the image quality of the aerial image is influenced by lens aberrations, illumination conditions, etc. The image quality can be evaluated by using a SEM (Scanning Electron Microscope) after exposing photo-resist coated on the wafer 1003 and developing the photo-resist. To save time and to reduce the influence of photo-resist properties, directly measuring aerial image 1008 is desirable. An aerial image 1008 is illustrated in FIG. 1B when the reticle 1002 has an object pattern (a transmittance pattern) 1005.

### SUMMARY OF THE INVENTION

According to an aspect of the present invention, it is provided that an apparatus includes an aperture configured to transmit light of an aerial image, a detector configured to detect the transmitted light at a plurality of first relative positions to the aperture, a controller configured to control a second relative position of the aperture to the aerial image, and a processor configured to generate information about the aerial image based on data obtained from the detector at each first relative position by controlling the second relative position of the aperture and position data about the first relative position.

According to another aspect of the present invention, it is provided that an apparatus includes an aperture configured to transmit light of an aerial image, a detector configured to detect the transmitted light at a plurality of first relative positions to the aperture along a direction, a controller configured to control a second relative position of the aperture to the aerial image along the direction, and a processor configured to generate information about the aerial image based on data obtained from the detector at each first relative position by controlling the second relative position of the aperture.

Further features of the present invention will become apparent from the following description of exemplary embodiments with reference to the attached drawings.

### BRIEF DESCRIPTION OF THE DRAWINGS

FIG. 1A illustrates a configuration of an optical lithography system used for manufacturing semiconductor devices.

FIG. 1B illustrates an object pattern and an aerial image.

FIG. 2A illustrates the aerial image measuring apparatus of the prior art.

FIG. 2B illustrates the aerial image and a measured image.

FIG. 3 illustrates an image recovery process.

FIG. 4 illustrates the change of cost function with respect to parameter values used for optimization calculations.

FIG. 5A illustrates an optical lithography system.

FIG. 5B illustrates an apparatus used to obtain information about an aerial image.

FIG. 6 illustrates a mechanism of aerial image formation.

FIG. 7 illustrates the influence of an aperture when a plane wave passes through the aperture.

FIG. 8 illustrates the aperture structure used in a first embodiment.

FIGS. 9A, 9B, 10A and 10B illustrate the optical properties of the aperture structure shown in FIG. 8.

FIG. 11 illustrates the profile change of measured aerial images.

FIG. 12 illustrates an image recovery process.

FIG. 13 illustrates the change of cost function with respect to parameter values used for optimization calculations.

FIG. 14 illustrates an initial function for the illumination distribution.

FIG. 15 illustrates an initial function for the distribution of diffraction beams.

FIG. 16 illustrates the operation of imaging performance check and correction.

FIG. 17 illustrates the aerial image measuring apparatus of in a second embodiment.

FIG. 18A illustrates a pinhole-type aperture.

FIGS. 18B and 18C illustrate a movable detector and a two-dimensional detector array, respectively.

### DESCRIPTION OF THE EMBODIMENTS

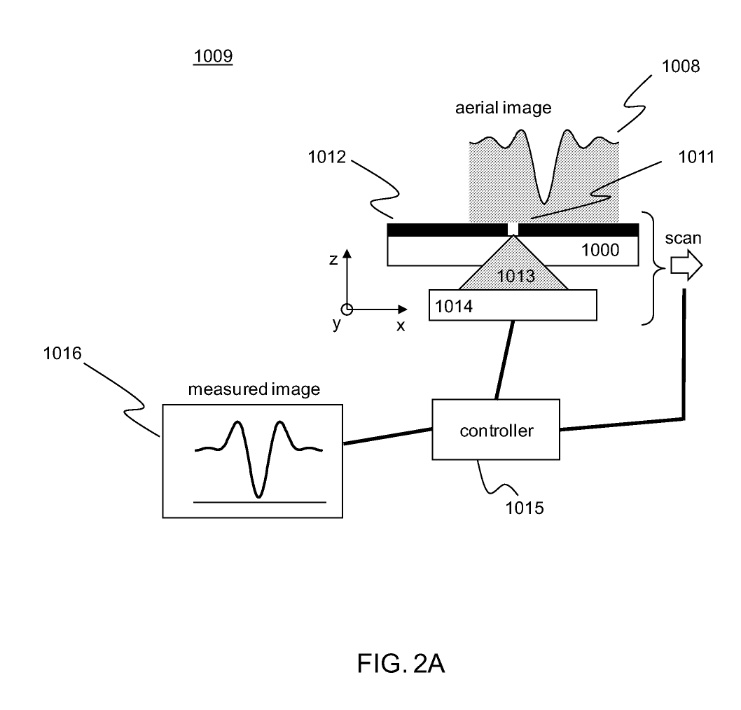

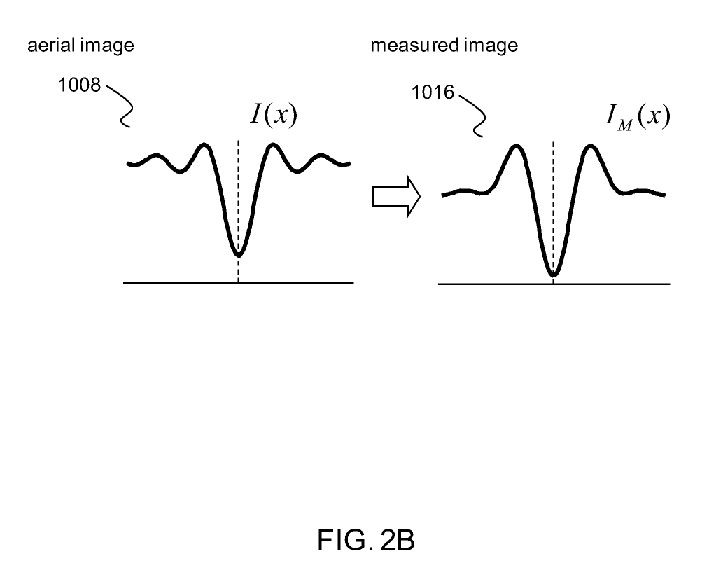

FIG. 2A shows an exemplary configuration of a measurement system including an apparatus 1009 to measure an optical intensity distribution corresponding to an aerial image 1008. The apparatus 1009 can include a light-blocking layer 1012 formed on a substrate 1000. The light-blocking layer 1012 has an aperture 1011 through which light beams of a predetermined wavelength can pass. The light beams that compose an aerial image 1008 pass through the aperture 1011 and the transmitted light 1013 reaches a detector 1014.

Measurement of the aerial image 1008 can be performed by scanning the aerial image through the aperture 1011. The scanning can be performed by properly controlling a wafer stage on which the substrate 1000 is provided. The operations of scanning, data acquisition from the detector 1014, and output of measured image 1016 can be controlled by a controller 1015. The measurements system can be used to create an image profile, which can be used to evaluate the image quality of an optical lithography system.

The aperture 1011 can be a slit, which is extended in the y-direction, or a pinhole. In order to realize high resolution in the measurement, the aperture size can be sufficiently narrower than the image feature, which means that the aperture size could be in a sub-wavelength region.

For simplicity, the aperture 1011 is assumed to be a slit extended in the y-direction and the aerial image 1008 is also assumed to be one-dimensional, which is invariant in the y-direction. One-dimensional test patterns can be used for the purpose of an imaging performance evaluation. In FIG. 2A, the image location can be fixed, and the image intensity distribution of the aerial image 1008 can be measured by scanning in the x-direction.

FIG. 2B shows the comparison between the aerial image 1008 represented by I(x) and a measured image 1016 represented by I_{M}(x). As shown in FIG. 2B, the profile of I_{M}(x) may be significantly changed from the profile of I(x).

It should be understood that there is a difference between the aerial image 1008 and the measured image 1016 (i.e., the measurement result of the aerial image). The aerial image 1008 is an image that would have been formed on a wafer if the wafer had been positioned by a wafer stage beneath a projection lens. If it is measured using an aperture (a slit) of sub-wavelength size, the profile of the aerial image is subject to change because of inherent optical properties of the aperture.

The calculation, to obtain the actual aerial image that would have been created on the wafer if the wafer had been present based on the measured image data considering the optical properties of the aperture 1011, is called an image recovery system. Such calculation is executed to ensure high precision measurement.

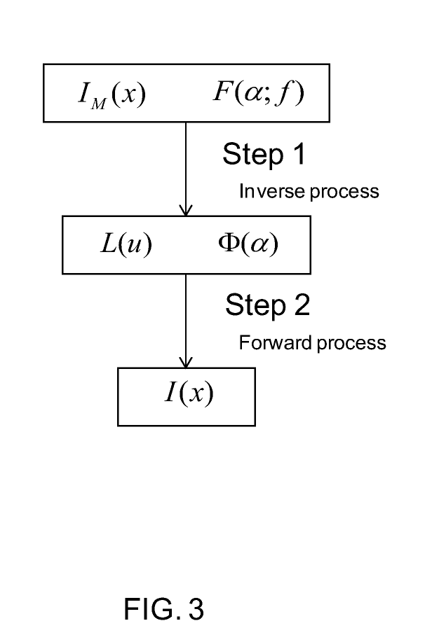

FIG. 3 illustrates the image recovery process, in which the profile of I(x) is computationally reconstructed by I_{M}(x) using the optical properties of the aperture 1011.

The image recovery process might not be straightforward in an optical lithography system. Since the behavior of an image formation in the optical lithography system is non-linear, and governed by partially coherent imaging theory, it might not be possible to fully recover an original aerial image formed on a wafer using measured image data as an “inverse problem”, or based on MTF (Modulation Transfer Function) analysis as mentioned in U.S. Pat. No. 5,631,731 or U.S. Pat. No. 5,866,935.

The image recovery in this case requires massive calculations including iterations. The calculation process is illustrated in FIG. 3, where I(x) is obtained using I_{M}(x) as well as a function F(α; ƒ) representing the optical properties of the aperture 1011. In FIG. 3, L(u) represents an optical intensity distribution of illumination beams formed by an illumination system, and Φ(α) represents a distribution of diffraction beams exiting from the object pattern (transmittance pattern).

The image recovery calculation can be composed of following two steps.

Step 1: L(u) and Φ(α) are deduced from I_{M}(x) and F(α; ƒ). This calculation step is an inverse process and requires non-linear optimization with iterations.

Step 2: Then, I(x) is calculated using the above obtained L(u) and Φ(α). This calculation process is a forward process.

In “Step 1”, L(u) and Φ(α) are obtained as a result of optimization with iteration calculations. The optimization is targeted to minimize the cost function:

Cost Function=[Î_{M}(x)−I_{M}(x)]² (1)

where Î_{M}(x) is calculated using \hat{L}(u) and \hat{Φ}(α) which are intermediate states of L(u) and Φ(α), respectively, and are varied in an appropriate manner during optimization.

When the value of Eq. (1) takes its global minimum (ideally zero), the interim functions \hat{L}(u) and \hat{Φ}(α) should be equal to L(u) and Φ(α), respectively. After determining the optimum functional form for \hat{L}(u) and \hat{Φ}(α), they are substituted to L(u) and Φ(α), respectively, and used for the calculation of the “Step 2”.

It is known that the above calculations have the following problems. L(u) and Φ(α) are not simple functions, but are composed of numerous data points which need to be optimized in Step 1. On the other hand, the amount of data constituting the cost function (1) is very limited since only one data set for measured image is available. In other words, too many parameters need to be optimized considering the amount of data available for the optimization. Furthermore, this process might be susceptible to noise in the measurement data.

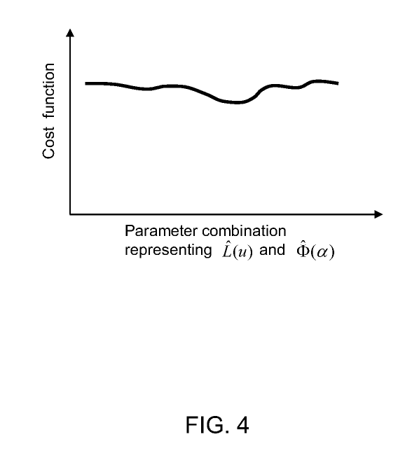

FIG. 4 illustrates the behavior of the cost function with respect to the change of parameters composing \hat{L}(u) and \hat{Φ}(α). It could be understood that finding the minimum in the cost function may be difficult. The calculations could be numerically unstable, and it may be possible that more than one parameter combination giving practically the same minimum value for the cost function are found. As a result, the image recovery process should be improved.

Exemplary embodiments according to the present invention will be described below with reference to the attached drawings. The same reference numerals denote the same members throughout the drawings, and a repetitive description thereof will not be given.

### First Embodiment

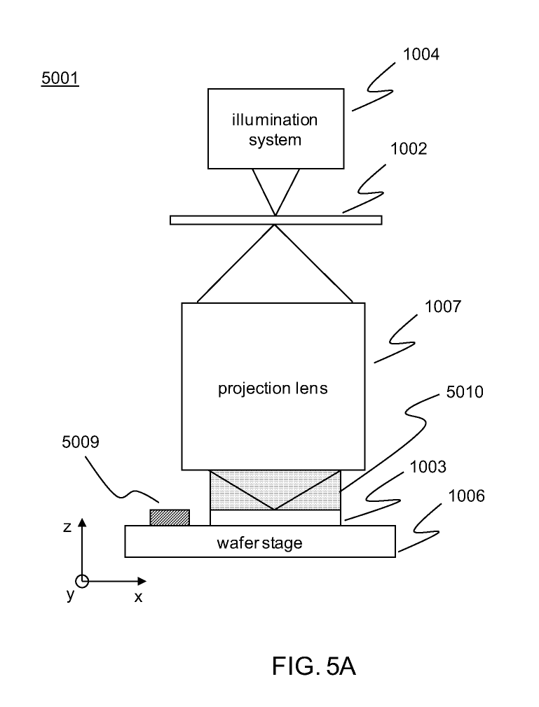

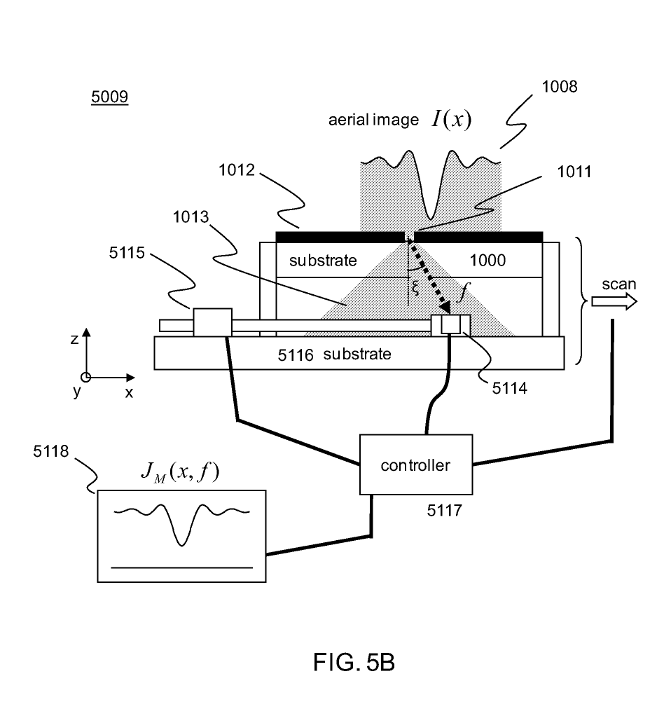

As described above, FIG. 5A shows the configuration of an optical lithography system 5001, which includes an apparatus 5009, used for the manufacturing of semiconductor devices. An object pattern on a reticle 1002 is projected onto wafer 1003, where an aerial image corresponding to the object pattern is created. The apparatus 5009 can be used for obtaining information about the aerial image.

The apparatus 5009 for an image measurement that enables accurate image recovery calculations will be described in detail.

FIG. 5B illustrates a configuration of the apparatus 5009 that may be equipped on the wafer stage 1006. The apparatus 5009 can include an aperture 1011 to transmit light of the aerial image. The aperture can be obtained, for example, by using a light-blocking layer 1012 formed on a substrate 1000. The aperture 1011 could be a slit or a pinhole. The slit as the aperture 1011 is used in the example described below. Light beams of a predetermined wavelength, which forms the aerial image, can pass through the slit. In order to realize high resolution in the measurement, the aperture width is sufficiently narrower than the image feature, which means that the aperture size can be in the sub-wavelength region.

Light beams that compose the aerial image 1008 pass through the aperture 1011 and a portion of transmitted light 1013 can reach a detector 5114. Instead of measuring the total intensity of transmitting light 1013, the detector 5114 can measure a portion of transmitted light 1013, where the portion is specified by the angle ξ or its direction cosine ƒ=sin ξ. The detector 5114 can detect the transmitted light at a plurality of first relative portions to the aperture 1011 along a direction (e.g., x direction). Position data about the first relative positions can be specified by using the angle ξ. The position data may be prepared as a data table before the detecting. The position data can be obtained every the detecting.

To measure the profile of the aerial image 1008 along, for example, the x-axis as shown in FIG. 5B, the apparatus 5009 can scan the aerial image 1008 in the direction (e.g., x direction).

The first relative position between the aperture 1011 and the detector 5114 can be maintained during each scanning operation. The scanning operation can be executed by a controller 5117 which controls a second relative position of the aperture 1011 to the aerial image 1008. Then, a measured image 5118, represented by J_{M}(x, ƒ), can be created mainly by the portion of transmitted light specified by ƒ=sin ξ.

In this embodiment, the scanning operation is repeated for plural times (K times) after changing the first relative position between the aperture 1011 and the detector 5114. The first relative position can be controlled by a detector position controller 5115. As a result, a total of K data for J_{M}(x, ƒ) are obtained with different values of ƒ=sin ξ. Note that the K image profiles are different from each other as far as the associated value of ƒ=sin ξ are different. Instead of moving the detector 5114 to change the first relative position, a detector array which comprises a plurality of image pick-up devices can be used. Prior to the scanning operation to change the second relative position, the detector 5114 can detect the transmitted light at the plurality of the first relative positions while maintaining a certain second relative position of the aperture 1011, and then the second relative position can be moved. The scanning operation to change the second relative position and the detecting operation to detect the transmitted light at the plurality of the first relative positions might be substantially executed at the same time by using the detector array.

The detector 5114 and the detection position controller 5115 can both be attached on a substrate 5116, which can be attached to the wafer stage 1006 shown in FIG. 5A. Then the scanning operation can be performed by properly controlling the wafer stage 1006. The operations of scanning, data acquisition from detector 5114, and data output of measured image 5118 can be controlled by the controller 5117. Based on the data obtained from the detector 5114 at each first relative position by controlling the second relative position of the aperture 1011, a processor can generate information about the aerial image 1008 based on data obtained from the detector 5114 at each first relative position by controlling the second relative position of the aperture and position data about the first relative positions as described below. The information can comprise a result of aerial image measurement.

For simplicity, the aerial image 1008 and the aperture 1011 are assumed to be one-dimensional (i.e. invariant in the y-direction). One-dimensional test patterns are used for the purpose of imaging performance evaluations. In FIG. 5B, the image location can be fixed, and the image intensity distribution can be measured by scanning in the x-direction. The aperture 1011 is assumed to be one-dimensional, which means its length in the y direction is substantially larger than that of the x direction.

The fact that measured image J_{M}(x, ƒ) depends on ƒ=sin ξ has been found through intensive research by the inventor of the present invention, and constitutes theoretical foundation of the invention.

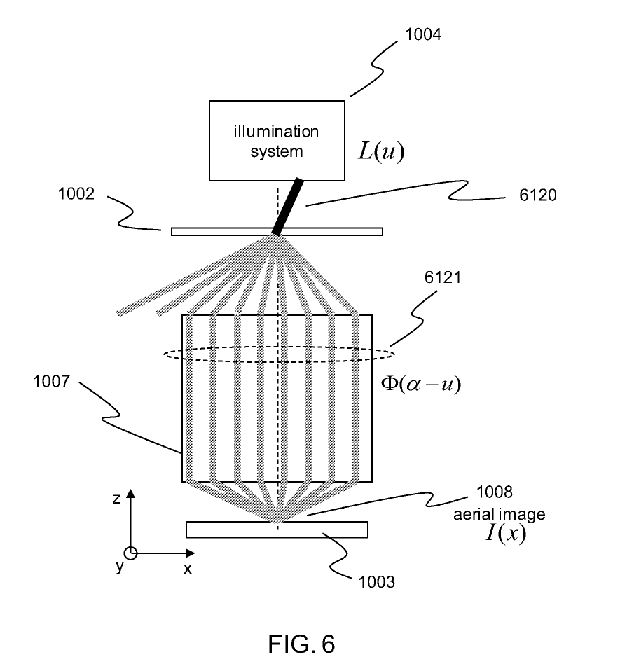

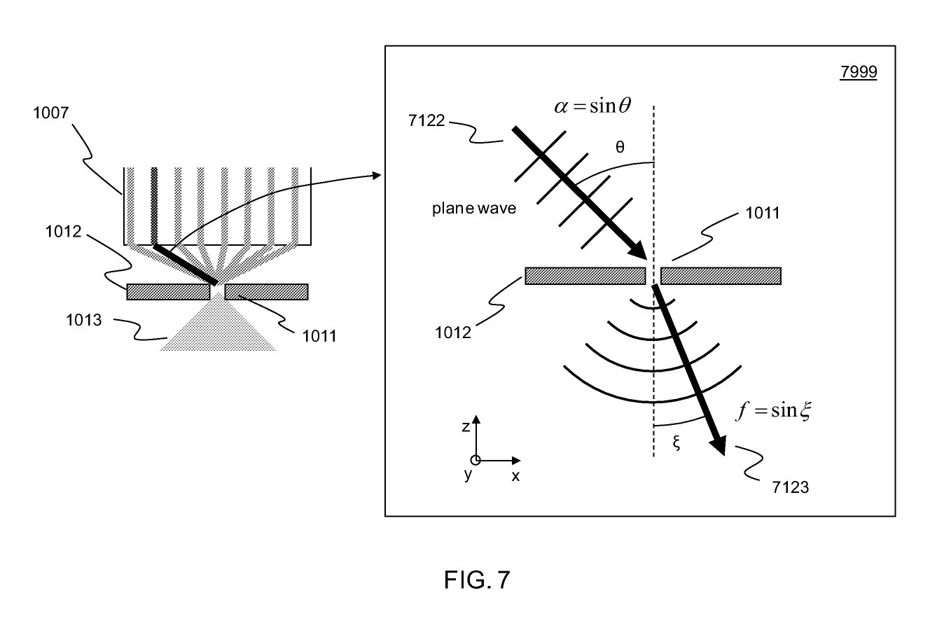

The profile of the measured image J_{M}(x, ƒ) is changed from the aerial image I(x), because the aerial image I(x) can be influenced when the light of the aerial image transmits the slit as the aperture. Here, the mechanism of such image profile change is explained using FIGS. 6 and 7.

The aerial image 1008 on the wafer 1003 is created as a result of interference between diffraction beams 6121 captured by the projection lens 1007. In an actual exposure system, the illumination system 1004 provides illumination beams that illuminate the reticle pattern 1002 with different angles. Such illumination distribution is denoted by L(u).

In FIG. 6, only one illumination beam 6120 is depicted for simplicity. The distribution of diffraction beams 6121 on a lens pupil in the projection lens 1007 is described by Φ(α−u). Then, the image intensity on the wafer 1003 is given, based on partially coherent imaging theory, by

I(x)=∫L(u)|∫_{-α}_{ₘₐₓ}^{α}^{ₘₐₓ}Φ(α−u)exp(−i2παx/λ)dα|²du (2)

where αₘₐₓ limits the range of diffraction beams that are captured by the projection lens 1007. Eq. (2) represents the profile of aerial image 1008.

FIG. 7 illustrates what happens when the wafer 1003 is replaced by the aperture (slit) 1011. In partially coherent imaging theory, each diffraction beam is modeled as a plane wave, such as the plane wave 7122 specified by the direction cosine of α=sin θ as shown in 7999 of FIG. 7. The plane wave 7122 is then converted to a quasi-cylindrical wave 7123 by transmitting through the aperture (slit) 1011. The amplitude and the phase of quasi-cylindrical wave 7123 depend on its propagating direction specified by the direction cosine of ƒ=sin ξ, which means that the beam is not a perfect cylindrical wave.

More generally, the aperture (slit) 1011 can work as an optical device that converts the incident plane wave 7122 to the quasi-cylindrical wave 7123, and its optical properties can be described by a complex function F(α; ƒ), where α=sin θ and ƒ=sin ξ.

Using the function F(α; ƒ), it can be shown after careful analysis that the profile of the measured image 1016 in FIG. 2B is given by

I_{M}(x)=∫L(u)[∫_{-ƒ}_{ₘₐₓ}^{ƒ}^{ₘₐₓ}|∫_{-α}_{ₘₐₓ}^{α}^{ₘₐₓ}Φ(α−u)F(α; ƒ)exp(−i2παx/λ)dα|²dƒ]du (3)

where αₘₐₓ restricts the range of beam directions entering the slit and ƒₘₐₓ limits the range of beams captured by the detector. The numerical aperture of projection lens 1007 is given by n×αₘₐₓ where n is the refractive index of a medium between the projection lens 1007 and the wafer 1003. The medium could be air or water, for example.

In a case of F(α; ƒ)=1, it is obvious that Eq. (3) is reduced to Eq. (2). In general, however, the optical properties of aperture (slit) 1011 given by F(α; ƒ) depend on α and ƒ; then the image profile given by Eq. (3) will be different from the one given by Eq. (2).

The image recovery process using the distribution of Eq. (3) is presented in FIG. 3, in which the profile of aerial image 1008 I(x) is recovered from the measured image I_{M}(x). As mentioned before, the image recovery process of FIG. 3 results in poor accuracy due mainly to a limited amount of data for I_{M}(x).

This embodiment according to the present invention is based on the following theoretical analysis conducted by the inventor of the present invention.

After careful consideration, it is shown that Eq. (3) is transformed to

I_{M}(x)=∫_{-ƒ}_{ₘₐₓ}^{ƒ}^{ₘₐₓ}[∫L(u)|∫_{-α}_{ₘₐₓ}^{α}^{ₘₐₓ}Φ(α−u)F(α; ƒ)exp(−i2παx/λ)dα|²du]dƒ (4)

by interchanging the integration variables ƒ and u. Then, it is understood that the measured image 1016 (see FIG. 2B) given by Eq. (4) can be described as an integral of image components specified by ƒ.

By assuming that the parameter ƒ is discrete, and ƒₙ with n: 1˜N represents the whole range of ƒ, Eq. (4) is transformed to

$$\begin{matrix}\begin{matrix}{I}_{M} ( x ) = {\sum }_{n = 1}^{N} \int L ( u ) {\vert {\int }_{- {α}_{max}}^{{α}_{max}} Φ ( α - u ) F ( α ; {f}_{n} ) exp ( - i2πα x / λ ) d α \vert}^{2} d u \\ = {\sum }_{n = 1}^{N} {J}_{M} ( x , {f}_{n} )\end{matrix} & ( 5 ) \\ with & \\ {J}_{M} ( x , {f}_{n} ) = \int L ( u ) {\vert {\int }_{- {α}_{max}}^{{α}_{max}} Φ ( α - u ) F ( α ; {f}_{n} ) exp ( - i2πα x / λ ) d α \vert}^{2} d u & ( 6 )\end{matrix}$$

It is understood that Eq. (6) represents the profile of measured image 5118 in FIG. 5. By repeating the measurement for K times, a total of K image data given with ƒₖ (k: 1˜K) in Eq. (6) can be obtained. Since the function F(α; ƒₖ) depends on ƒₖ, the K images can be different from each other.

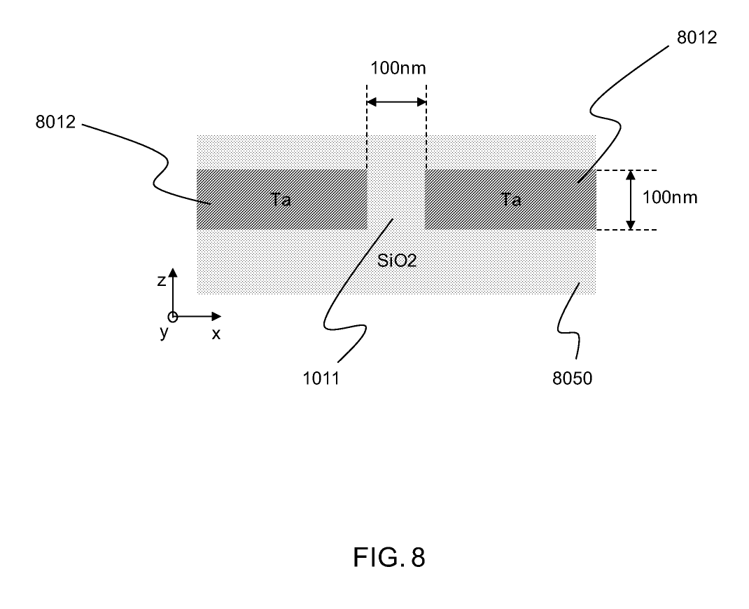

A structure of aperture (slit) 1011 used for aerial image measurement is shown in FIG. 8. Ta (Tantalum) 8012 can be used as a light blocking layer 1012, and SiO2 (fused silica) 8050 can be used as the substrate 1000. When the medium between the projection lens 1007 and the wafer 1003 is water instead of air, the aperture space can be filled with SiO2. The SiO2 can also cover the top of Ta layer to prevent water intrusion as necessary.

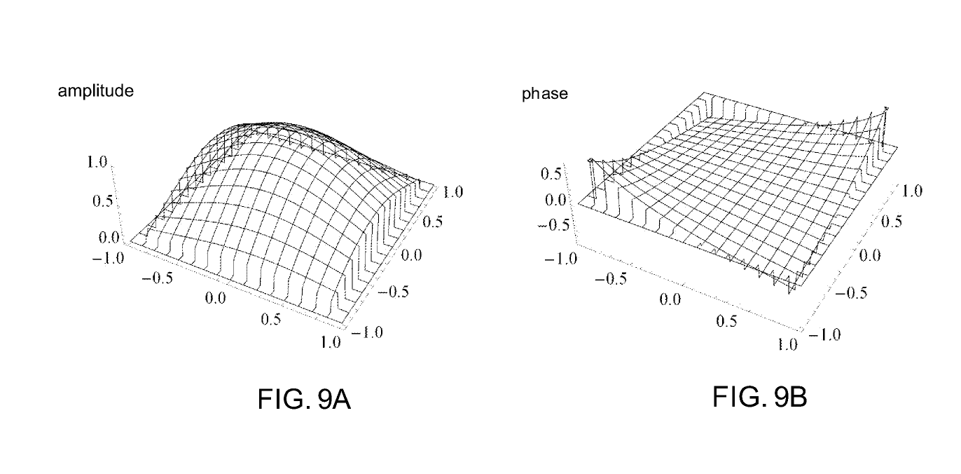

The optical properties F(α; ƒ) of the slit structure shown in FIG. 8 can be calculated by FDTD (Finite-difference time-domain) method. For simulations, the thickness of Ta is assumed to be 100 nm, and the aperture (slit) width is assumed to be 100 nm. The results are shown in FIGS. 9A and 9B as amplitude and phase distributions, each as functions of α and ƒ.

Here, we consider the case of K=4, with ƒ₁=0.0, ƒ₂=0.2, ƒ₃=0.4, and ƒ₄=0.6.

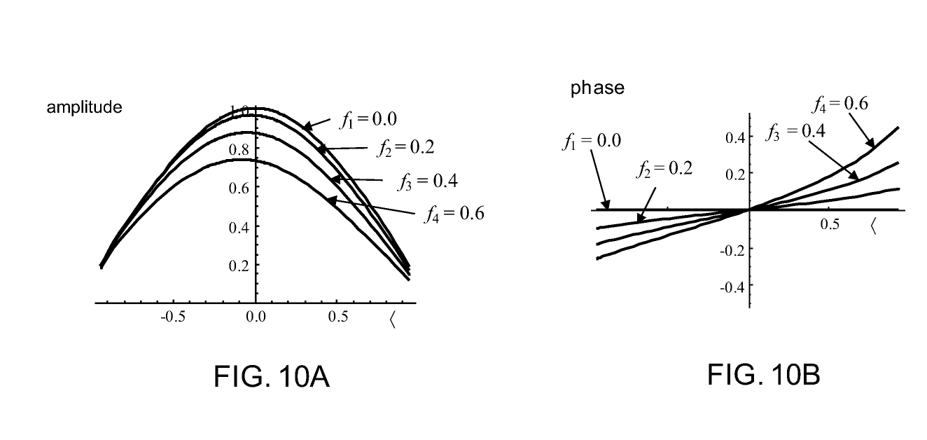

The optical properties of the slit for each ƒₖ are presented in FIGS. 10A and 10B as functions of α. These data are consistent with FIGS. 9A and 9B.

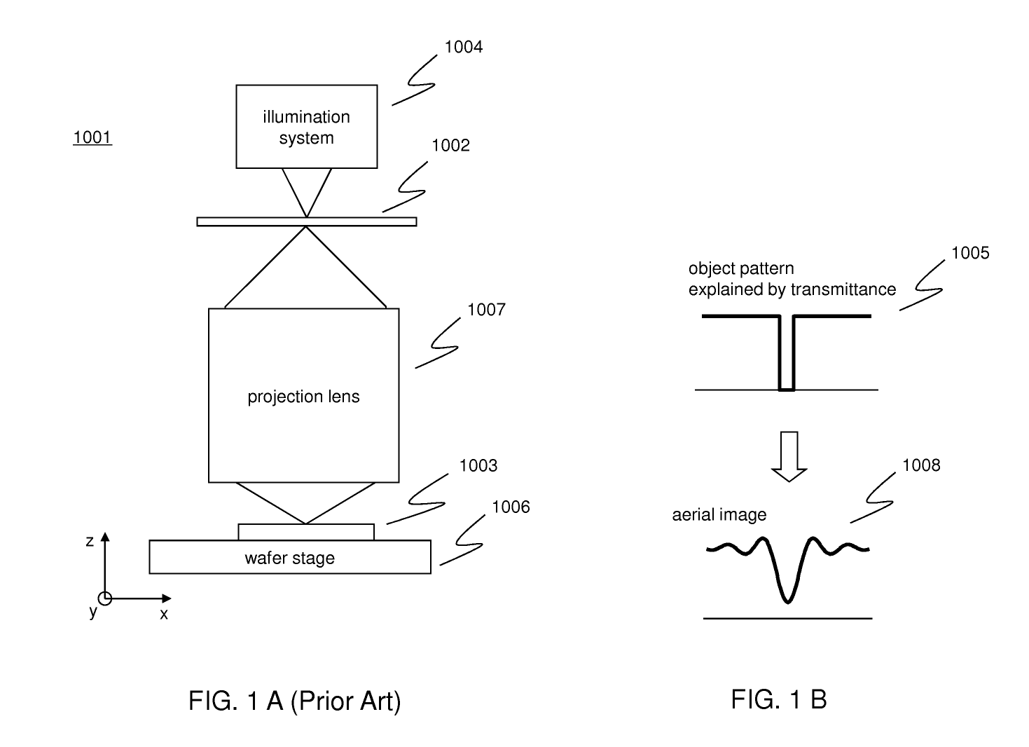

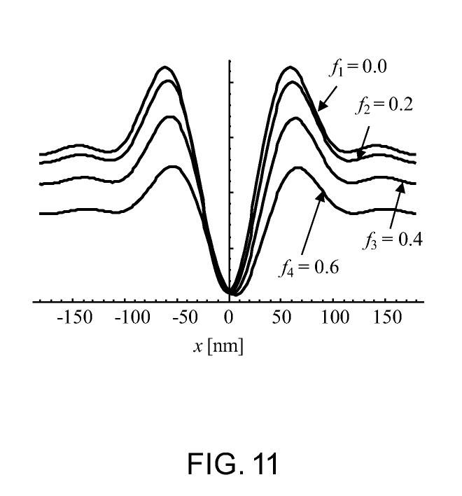

Measured image profiles obtained for the object pattern 1005 (see FIG. 1B) are illustrated in FIG. 11 for each value of ƒₖ (k: 1˜4). These four images can be measured sequentially by repeating scanning operation, with properly adjusting the position of the detector 5114 for each of the scans.

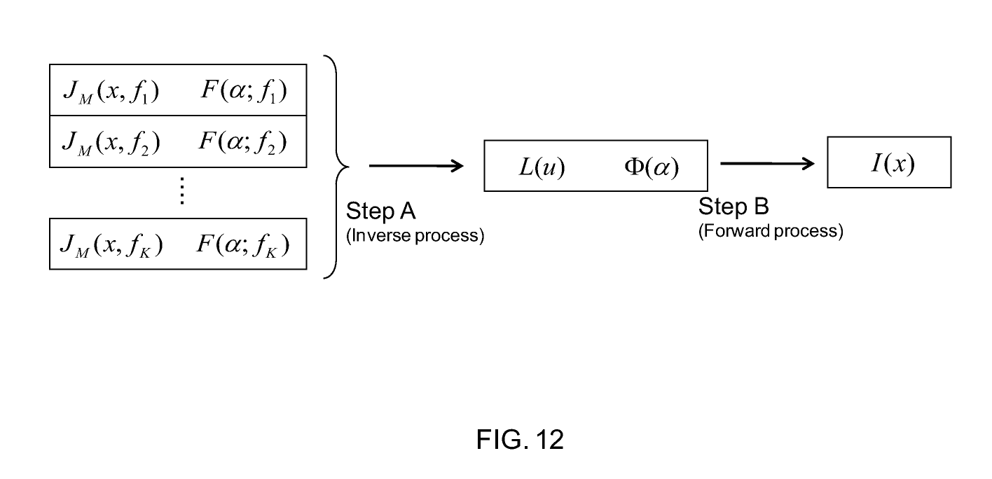

Using K measured image data J_{M}(x, ƒ₁)˜J_{M}(x, ƒ_{K}) together with K slit-property functions F(α; ƒ₁)˜F(α; ƒ_{K}), the image recovery process illustrated by FIG. 3 can be modified to FIG. 12. This time, we can use K distinct image data to estimate the values of numerous parameters in the functions L(u) and Φ(α) in step A.

The image recovery process is explained in detail below.

In “Step A”, L(u) and Φ(α) are obtained as a result of optimization with iteration calculations. The optimization is targeted to minimize the cost function:

$$\begin{matrix} Cost Function = {\sum }_{k = 1}^{K} {[ {\hat{J}}_{M} ( x , {f}_{k} ) - {J}_{M} ( x , {f}_{k} ) ]}^{2} \\ where & ( 7 ) \\ {\hat{J}}_{M} ( x , {f}_{k} ) = \int \hat{L} ( u ) {\vert {\int }_{- {α}_{max}}^{{α}_{max}} \hat{Φ} ( α - u ) F ( α ; {f}_{k} ) exp ( - i 2 πα x / λ ) d α \vert}^{2} d u & ( 8 )\end{matrix}$$

Ĵ_{M}(x, ƒₖ) is calculated using \hat{L}(u) and \hat{Φ}(α) which are intermediate states of L(u) and Φ(α), respectively, and are varied in an appropriate manner during optimization.

When the value of Eq. (7) takes its global minimum (ideally zero), the interim functions \hat{L}(u) and \hat{Φ}(α) should be equal to L(u) and Φ(α), respectively.

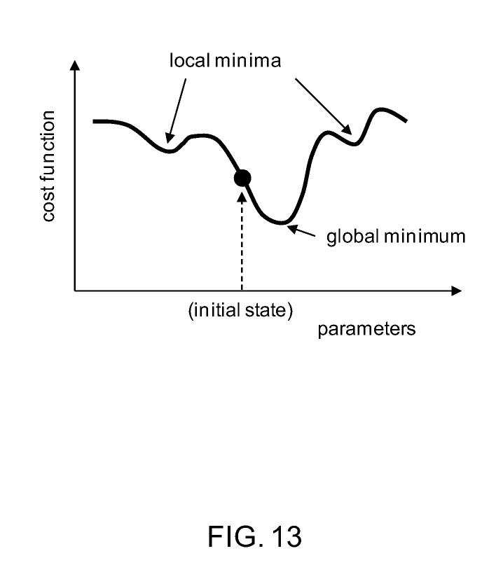

FIG. 13 illustrates the easiness of optimization process, when compared with FIG. 4. There exists a global minimum that is clearly distinguishable from local minima.

After determining the optimum functional form for \hat{L}(u) and \hat{Φ}(α), they are substituted to Eq. (2) in step B to obtain the profile of aerial image 5118 (see FIG. 5) eliminating the influence of slit transmission.

In “Step A” of FIG. 12, the choice of initial parameters is critical to reach the global minimum efficiently. In FIG. 13, a desirable position of an initial state is indicated by the filled circle.

In this embodiment, such initial state is specified by the design values for L(u) and Φ(α). As mentioned above, one of the purposes of aerial image measurement is to determine the deviation of optical characteristics from the design state. So, even though the actual forms for L(u) and Φ(α) are different from the design, it is expected that they are in the vicinity of the design state.

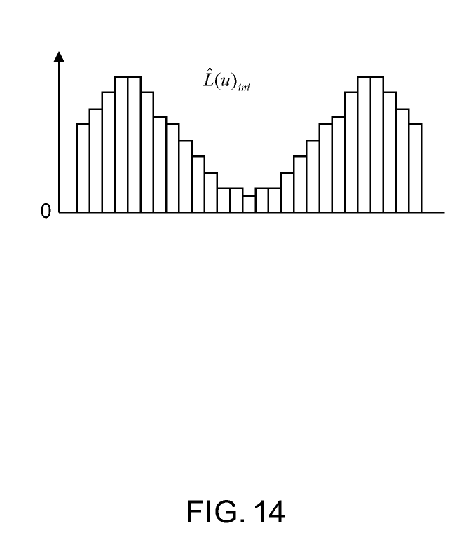

Herein, the initial states for L(u) and Φ(α) are represented by \hat{L}(u)ᵢₙᵢ and \hat{Φ}(α)ᵢₙᵢ, respectively. An example for the distribution of \hat{L}(u)ᵢₙᵢ is illustrated in FIG. 14. L(u) represents the intensity distribution of the illumination beam. It can have zero or positive values as a function of u. For the optimization purpose of Step A, the variable u is discretized, giving \hat{L}(u)ᵢₙᵢ and L(u) as a collection of discrete data points.

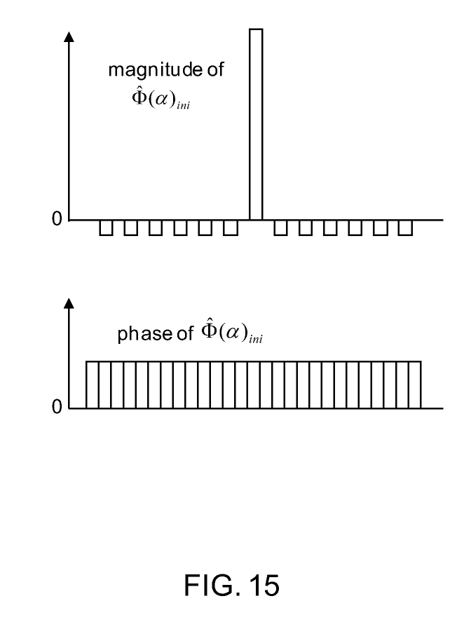

The magnitude and the phase of \hat{Φ}(α)ᵢₙᵢ are illustrated in FIG. 15, assuming the use of object pattern 1005 shown in FIG. 1. Φ(α) represents the distribution of diffraction beams, so its values are complex (designated by the magnitude and the phase). For the optimization purpose of Step A, the variable α is discretized, giving \hat{Φ}(α)ᵢₙᵢ and Φ(α) as a collection of discrete data points.

K=4 was chosen for the simplicity of explanations here. The number of K can be increased easily by repeating scanning operation with different positional setting for the detector 5114.

The above calculations can be conducted by a computer directly connected to the lithography system 5001, then the calculation results can be used for the correction of imaging performance of the lithography system. In an actual operation of lithography system 5001, it is required to check its optical performance periodically, and correct the performance if any degradation is observed.

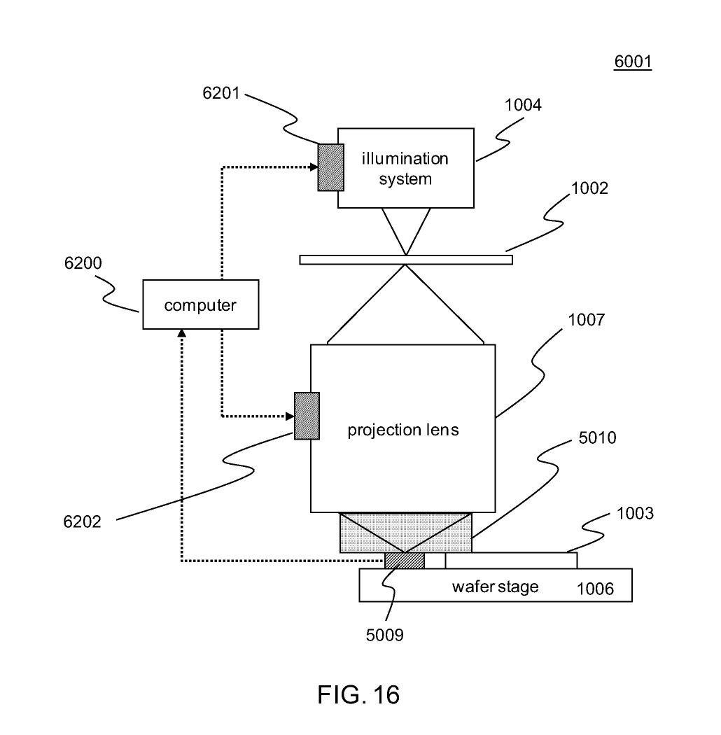

FIG. 16 illustrates a lithography system 6001 in which the result of aerial image measurement is used to check and correct (if necessary) the imaging performance of the system. The measurement apparatus 5009 is connected to a computer 6200 that conducts image recovery calculations described above. An illumination system control unit 6201 is implemented in the illumination system 1004 to slightly modify its characteristics by, for example, slightly moving optical elements in the illumination system 1004.

A projection lens control unit 6202 is implemented in the projection lens 1007 to slightly modify its characteristics by, for example, slightly moving optical elements in the projection lens. Based on the results of aerial image measurement, a computer 6200 can control the illumination system control unit 6201 and/or the projection lens control unit 6202 to improve the performance of lithography system 6001.

Advanced exposure systems typically employ “immersion technology” in which the space between the bottom lens element of the projection lens 1007 and a wafer 1003 may be filled with liquid 5010 to improve resolution shown in FIG. 5A. The resolution of optical lithography system 5001 is determined by a numerical aperture (NA) of projection lens 1007 and an exposure wavelength (λ). The resolution is given by R=k₁λ/NA, where k₁ is a process dependent factor usually between 0.3 and 0.5. An ArF excimer laser (λ=193 nm) can be used for illumination by an illumination system 1004. Liquid 5010 used for an immersion system is transparent at the 193 nm wavelength and has a refractive index (n) greater than 1. Purified water (n=1.44) is used as the liquid 5010 for the immersion system.

The first embodiment according to the present invention can be used to reconstruct the image profile (aerial image) based on the measurement result by slit scanning. This process involves an inverse problem. In the first embodiment, plural image profile data, which are distinct from each other and obtained by slit scanning, are used for the optimization calculation to solve the inverse problem. As a result, the aerial image profile can be reconstructed precisely.

An aerial image measurement described above can also be used for monitoring to compensate a lens unit, for illumination or projection, which might deteriorate with age.

### Second Embodiment

In the first embodiment described above, the scanning operation needs to be repeated for K times to obtain K measured image data J_{M}(x, ƒ₁)˜J_{M}(x, ƒ_{K}).

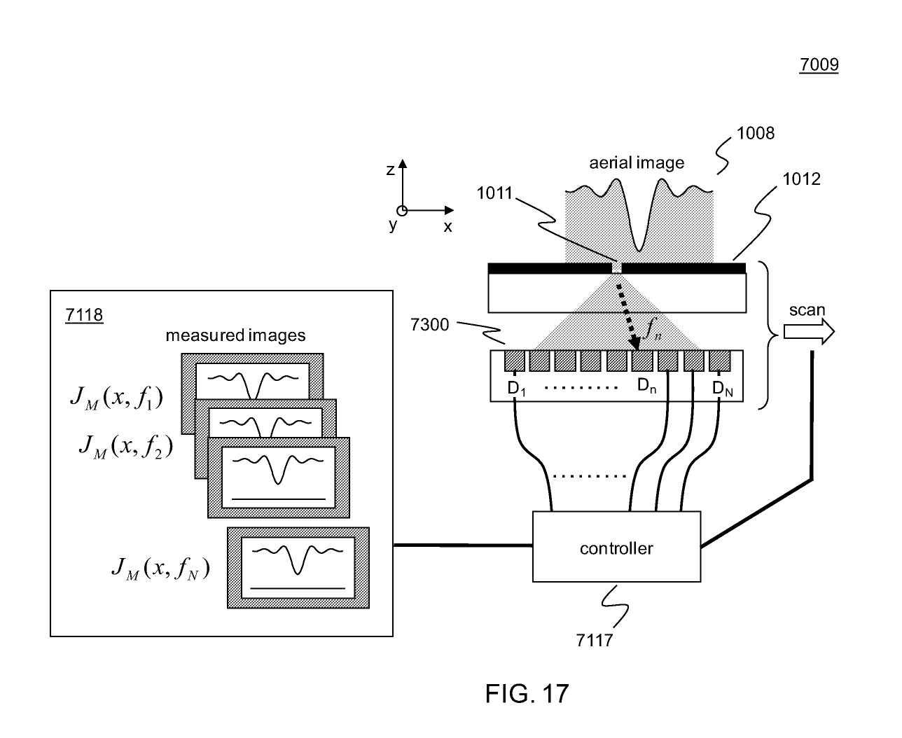

An apparatus 7009 for aerial image measurement is illustrated in FIG. 17 as a second embodiment. A detector array 7300 is composed of N detectors (D₁˜D_{N}), and the array can be connected to the aperture 1011 so that N images J_{M}(x, ƒ₁)˜J_{M}(x, ƒ_{N}) can be obtained by a single scan of the aperture 1011. Each detector can be controlled by a controller 7117. Measured images 7118 are illustrates in FIG. 17. After the measurement data is obtained, the image recovery process described in the first embodiment can also be applied.

### Third Embodiment

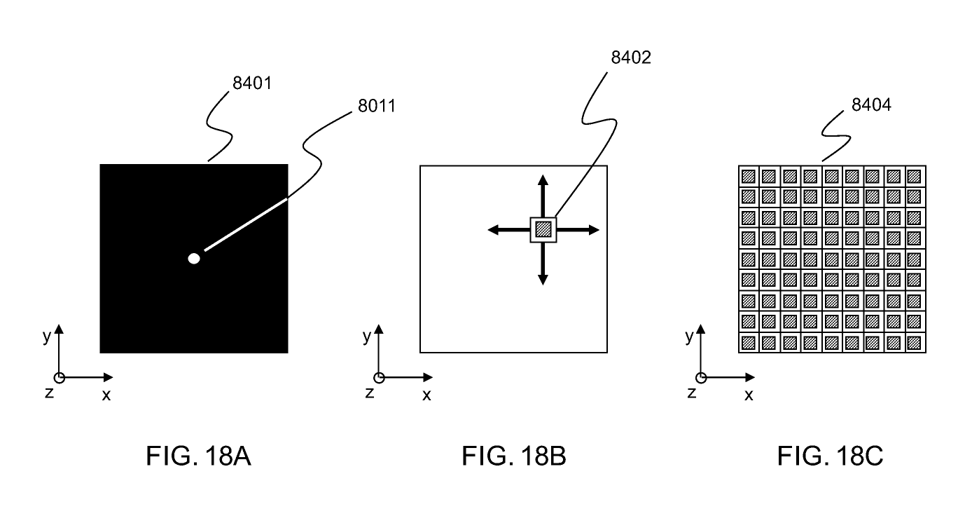

As a third embodiment, a pinhole-type aperture 8011 as shown in FIG. 18A can be used instead of a slit type aperture such as the one shown as shown in FIG. 8.

FIG. 18A is a top view of the pinhole-type aperture. The pinhole 8011 is created in a light blocking layer 8401. The pinhole-type structure can be used with a movable detector 8402 as shown in FIG. 18B, which can change its detecting position along x and y directions. An angular distribution may be measured. A two-dimensional detector array 8404 shown in FIG. 18C can be also used instead of the movable detector 8401.

While embodiments according to the present invention have been described with reference to exemplary embodiments, it is to be understood that the present invention is not limited to the above described embodiments. The scope of the following claims is to be accorded the broadest interpretation so as to encompass all such modifications and equivalent structures and functions.

What is claimed is:

1. An apparatus comprising:
an aperture configured to transmit light of an aerial image;
a detector configured to detect the transmitted light at a plurality of first relative positions to the aperture;
a controller configured to control a second relative position of the aperture to the aerial image; and
a processor configured to generate information about the aerial image based on data obtained from the detector at each first relative position by controlling the second relative position of the aperture and position data about the first relative positions.

2. The apparatus according to claim 1, wherein the aperture is provided with a substrate.

3. The apparatus according to claim 1, wherein the aperture comprises a slit.

4. The apparatus according to claim 1, wherein the aperture comprises a pinhole.

5. The apparatus according to claim 1, wherein the aperture is configured to convert a plane wave of the light of the aerial image to a quasi-cylindrical wave.

6. The apparatus according to claim 1, wherein the detector is configured to detect the transmitted light while maintaining the second relative position.

7. The apparatus according to claim 1, wherein the detector is movable to detect the transmitted light at the plurality of first relative positions.

8. The apparatus according to claim 1, wherein the detector comprises a detector array.

9. The apparatus according to claim 1, wherein a portion of the transmitted light is detected at each first relative portion.

10. The apparatus according to claim 1, wherein the controller is configured to control a position of the aperture to control the second relative position.

11. The apparatus according to claim 1, wherein the information is generated based on the data obtained from the detector at each first relative position and position data of the first relative position.

12. An apparatus comprising:
an aperture configured to transmit light of an aerial image;
a detector configured to detect the transmitted light at a plurality of first relative positions to the aperture along a direction;
a controller configured to control a second relative position of the aperture to the aerial image along the direction; and
a processor configured to generate information about the aerial image based on data obtained from the detector at each first relative position by controlling the second relative position of the aperture.

13. A lithography system comprising:
an illumination control unit;
a projection lens control unit; and
an apparatus comprising:
an aperture configured to transmit light of an aerial image;
a detector configured to detect the transmitted light at a plurality of first relative positions to the aperture;
a controller configured to control a second relative position of the aperture to the aerial image; and
a processor configured to generate information about the aerial image based on data obtained from the detector at each first relative position by controlling the second relative position of the aperture and position data about the first relative positions,
wherein the illumination control unit and the projection lens control unit are controlled based on the information about the aerial image.

14. The lithography system according to claim 13, wherein the apparatus is used for monitoring a lens unit comprising the lithography system.

15. A method comprising:
transmitting light of an aerial image through an aperture;
detecting the transmitted light at a plurality of first relative positions to the aperture;
controlling a second relative position of the aperture to the aerial image; and
generating information about the aerial image based on data obtained at each first relative position by controlling the second relative position of the aperture and position data about the first relative positions.

16. The method according to claim 15, wherein the aperture comprises a slit.

17. The method according to claim 15, wherein the aperture comprises a pinhole.

18. The method according to claim 15, wherein the aperture functions to convert a plane wave of the light of the aerial image to a quasi-cylindrical wave.

19. The method according to claim 15, wherein the transmitted light is detected while maintaining the second relative position.

20. The method according to claim 15, wherein the transmitted light is detected at the plurality of first relative positions by moving a detector.

21. The method according to claim 15, wherein the transmitted light is detected at the plurality of first relative positions by using a detector array.

22. The method according to claim 15, wherein a portion of the transmitted light is detected at each first relative portion.
